(19) United States
(12) Patent Application Publication
(10) Pub. No.: US 2010/0167602 A1
(43) Pub. Date: Jul. 1, 2010

(54) Energy system and boat

(76) Inventor: Thang D. Vu, Crystal, MN (US)

Correspondence Address: Gearhart Law LLC, 4 Femdale Avenue, Chatham, NJ, 07928, US

(21) Appl. No.: 12/653,546

(22) Filed: Dec. 15, 2009

Related U.S. Application Data
(60) Provisional application No. 61/201,914, filed on Dec. 16, 2008.

(51) Int. Cl. B63H 21/17; F03D 3/00; F03D 9/02; B63B 7/00; B63B 17/02; B63H 25/06

(52) U.S. Cl. 440/6; 290/55; 290/50; 114/345; 114/361; 114/162

(57) ABSTRACT

In one possible implementation the invention is electrical generating system, having: a wind power assembly having at least two rotatable propulsion systems: said wind power assembly further having an air pump, the air pump being connected to the wind power assembly and creating an air flow when rotatable propulsion systems rotate in response to wind; and an air powered generator connected to the wind power assembly, the air powered generator capable of creating electrical current as a result of the air flow from the wind power assembly. In another possible the invention is a boat having a hull, and a power system having a wind power assembly having at least one rotatable propulsion system: said wind power assembly further having an air pump, the air pump being connected to the wind power assembly and creating an air flow when rotatable propulsion systems rotate in response to wind; an air powered generator connected to the wind power assembly, the air powered generator capable of creating electrical current as a result of the air flow from the wind power assembly wherein the electrical current powers a motor that rotates a propeller external to the hull.

### CLAIM OF PRIORITY

This application claims priority to U.S. Ser. No. 61/201,914 filed Dec. 16, 2008, the contents of which are fully incorporated herein by reference.

### FIELD OF THE INVENTION

The invention relates wind-generated electricity and boats driven by electric motors.

### BACKGROUND OF THE INVENTION

The invention is an electric power system, which uses wind to generate electricity, which may be used to drive motors, illuminate lights, charge batteries and other electrical devices. An application of this system as applied to boats is also described.

### Description of Related Art

U.S. Pat. No. 4,329,593 teaches cup-type impellers which are utilized on wind energy machines which are driven according to a first embodiment to rotate about a vertical axis and according to a second embodiment to rotate about a horizontal axis. In the vertical axis embodiment, the shaft driven by the cups is coupled to one or more offset generators by a gear. Preferably, a single generator mounted to rotate about a vertical axis is utilized. The rotor of the generator is supported by a low friction vertical bearing. In a second embodiment, a pair of cone supports is utilized to drive a horizontally disposed shaft. The shaft is oriented normally with respect to wind direction by utilizing a wind vane mounted on a separate support which detects wind direction and transmits information regarding wind direction to a platform supporting the drive shaft. Preferably, the generator is mounted directly on the drive shaft.

U.S. Pat. No. 4,419,587 teaches wind responsive power generating apparatus having a pair of normally mutually orthagonal cross arms carrying impeller members that apply torque to a load through an output shaft. The power output of the apparatus is reduced from maximum by reducing the angle between adjacent cross arms and simultaneously rotating impeller members about corresponding cross arm axes to provide air spillthrough. The impellers are selectively vented by valves to reduce drag as each impeller member swings upstream. Operation of the valves is synchronized to impeller rotation and wind direction by a synchronization device. Various different types of impeller members and applications are disclosed.

U.S. Pat. No. 4,508,972 teaches airfoils that are secured to the frame of a vertical axis windmill to provide vertical lift to a rotatable vertical shaft and to armatures of electrical generators, thereby eliminating friction between each armature and its end bearing as well as between the vertical shaft and its end bearing. An indicator provides an indication that the generators of the windmill are generating an alternating electrical current having at least a predetermined voltage magnitude.

U.S. Pat. No. 5,009,569 teaches a wind-driven apparatus for the conversion of kinetic energy in the form of wind to rotational mechanical energy. This apparatus incorporates a funnel that directs wind against a collector causing it to rotate. To prevent any backpressure in the funnel or against the collector, the area immediately downstream of the collector is free of any obstacle or channeling devices. To also prevent any backpressure from developing, a series of blow-through panels form a part of the funnel which open upon the presence of high pressure--the greater the pressure, the greater the opening.

U.S. Pat. No. 5,455,485 teaches a lighting system, in particular for bicycles, which operates in accordance with the principle of a wind generator. The lighting system is mounted at the front of the bicycle above the front wheel. A system comprising a dynamo, propeller, electrical circuit, battery and lighting devices which are adapted to each other permits the illumination of a tail light even when stationary. A voltage monitor and an overload protector are part of the circuit.

U.S. Pat. No. 6,838,782 teaches a wind energy capturing device for moving vehicles including a wind turbine powered electrical power generator for installation on the roof of a moving vehicle such as a truck cab or tractor. The invention takes advantage of the powerful wind force generated by the vehicle moving on the road at moderate to high speed impinging against the wind deflector mounted on the truck cab or tractor. This otherwise “wasted” wind energy is captured and directed to the face area of the rotor blade, rotating the turbine, which, in turn, drives the generator to generate electricity. The electrical energy may be stored in a battery system and used to drive the motors of an electric vehicle or hybrid-electric vehicle.

U.S. Pat. No. 6,929,671 teaches an invention relates to a combination air purifier and wind generator. The combination air purifier and wind generator includes a wind-receiving unit installed on a central shaft for driving an electric generator mounted in a housing, and an air purifier. The wind-receiving unit includes a governor fixed to an upper end of the central shaft, a spherical blower installed in the middle of the central shaft, and planar magnetic rotary plates installed at a lower end of the central shaft for receiving both artificial and natural winds. Lower magnets are attached to the top of the housing while upper magnets having the same polarity as the lower magnets are attached to the bottoms of the magnetic rotary plates to face the lower magnets. The air purifier includes two air inlets; one air outlet; a copper net, a silver net and a hard charcoal/zeolite net disposed within the air purifier for purifying air introduced thereinto; and a blower interposed between the silver net and the hard charcoal/zeolite net.

U.S. Pat. No. 6,948,905 teaches a horizontal wind generator comprises a horizontal windmill drivingly coupled to an electrical generator. The windmill includes a vertical drive shaft mounted for rotation in a base, with a plurality of wind drive units being mounted in wind catching positions at spaced axial locations along the drive shaft. The drive units comprise oppositely facing wind catching elements mounted on opposite sides of crossbars or frames non-rotatably attached to the pole. Multiple wind drive units are spaced along the pole and angularly displaced from adjacent units at regular intervals around the pole. Two or four spaced drive units are particularly desirable. Wind catcher elements formed of cup shaped bowls or split barrels are particularly effective and are inexpensive. The wind generator is drivingly attached to an electrical generator through a gear box and belt or chain drive mechanism. The horizontal windmill rotates the electrical generator within its desired speed range without any governor or speed control.

U.S. Pat. No. 7,186,083 teaches A wind energy conversion device includes a propeller in which each of the propeller blades includes a proximal (radially inward) non-airfoil mounting section, a medial section and a distal tip section mounted to pivot relative to the medial section about a pitch axis running lengthwise of the blade. At low wind speeds, each tip section and its associated medial section cooperate to provide a single airfoil. When the propeller rpm exceeds a predetermined threshold, each of the tip sections begins to pivot toward a full governing position, which tends to reduce the propeller rpm. To permit wind tracking, the device is mounted to pivot on a vertical axis. The propeller blades are downwind of the vertical axis, and slightly inclined to define a cone diverging in the downwind direction. The electrical power generating components are located upwind of the propeller and centered about the propeller axis, and have a radius less than the length of the proximal blade sections. Forming the airfoil component of the blade in several sections (medial section, tip section and further sections as desired) facilitates fabrication by injection molding.

U.S. Pat. No. 7,211,905 teaches a vehicle-mounted generator is powered by relative wind produced by the combination of ambient wind and motion of the vehicle, or by movement of water when mounted on the hull of a water-borne vehicle. A rigid cylindrical housing forms an enclosed interior chamber. Wind asymmetrically enters the chamber through an inlet located on one side of a central longitudinal drive shaft, and exits through an outlet located at the top of the housing. A spiraling parabolic deck forms a floor of the interior chamber, and spirals around the central longitudinal shaft from the bottom of the housing to the outlet at the top. A turbine mounted on the drive shaft within the outlet converts energy of the exiting wind to mechanical energy. An electrical generator converts the mechanical energy into electrical energy for recharging a battery or powering an electric motor.

U.S. Pat. No. 7,358,624 teaches a wind-driven power source comprises a propeller-driven rotor structure and a stator structure carrying clusters of copper-wire wound ferromagnetic cores as voltage generators. The cores are arranged in pairs spaced apart by hard rubber rollers which engage the inside surface of a load ring forming part of the rotor structure. The overall rotor structure comprises the large diameter load ring, a smaller diameter root ring and a plurality of aerodynamic blades extending radially outwardly from the root ring and secured either by saddle blocks or integral bonding to the load ring. The load ring may be aluminum or plastic. Permanent magnets are arranged around the load ring to interact with the voltage generator structures to produce three-phase electricity.

Japan Patent No. 123639 teaches a wind electrostatic generator includes a wind mill 2 rotated by wind, a step-up gear 4 connected to an axle of the wind mill 2, an electrostatic generator 10 connected to an output axle of the step-up gear 4 and for generating static electricity.

### SUMMARY OF THE INVENTION

The invention is an article of manufacture that is a wind power assembly having at least two rotatable propulsion systems; said wind power assembly further having an air pump, the air pump being connected to the wind power assembly and creating an air flow when rotatable propulsion systems rotate in response to wind; and an air powered generator connected to the wind power assembly, the air powered generator capable of creating electrical current as a result of the air flow from the wind power assembly. Wind is captured and turned in mechanical force, which is used to drive an air pump producing air pressure, which is used to drive a generator. In another embodiment, the electrical energy is used to power a boat.

An object of this invention is to generate electricity in situations where wind is available but other sources electrical generating input are hard to utilize. Another object of this invention is to reduce reliance on fossil fuels by the harnessing of wind energy, which also reduces pollution.

### BRIEF DESCRIPTION OF THE DRAWINGS

FIG. 1 shows a preferred embodiment of the invention as an electric generating system.

FIG. 2 shows a detailed view of a rotatable propulsion system.

FIG. 3 shows a preferred embodiment of the invention as a boat in a side view.

FIG. 4 shows a preferred embodiment of the invention as a boat in a cut-a-way view.

### DESCRIPTION OF THE PREFERRED EMBODIMENTS

The preferred embodiments of the present invention will now be described with reference to the drawings. Identical elements in the various figures are identified with the same reference numerals.

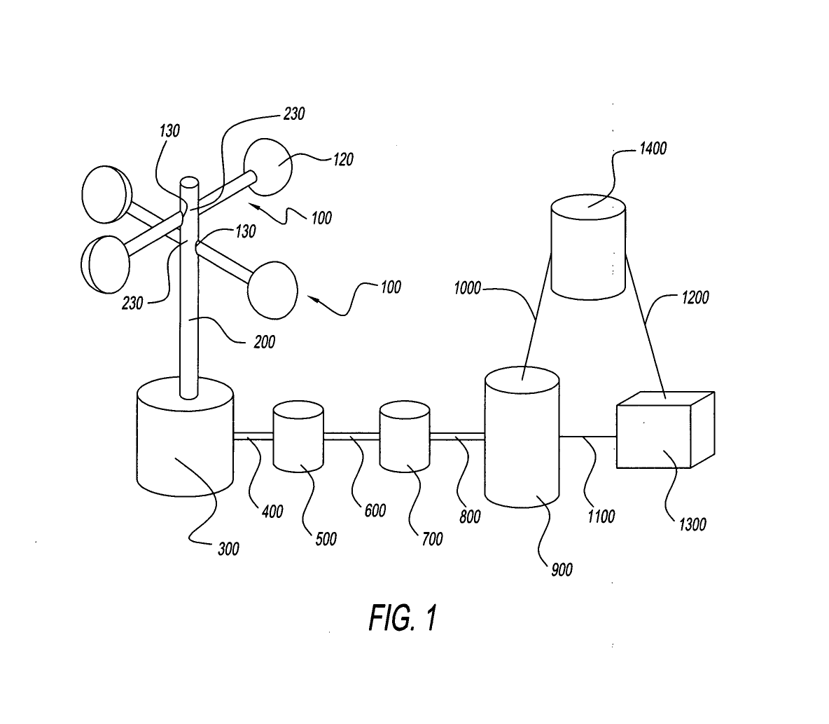

FIG. 1 shows a preferred embodiment of the invention as an electric generating system. The preferred embodiment has two rotatable propulsion systems 100, a mast 200, air pump 300, first air valve 500, second air valve 700, air powered generator 900, battery 1300 and/or electric motor 1400. Each rotatable propulsion system 100 is shown with a rotatable propulsion system connector 130 with rotatable propulsion system wind cups 120 that is shown connecting to the mast connector 230. The mast 200 is shown connected to the air pump 300. The preferred embodiment is shown with the following air hose connections: first air hose 400 from air pump 300 to first air valve 500; second air hose 600 from first air valve 500 to second air valve 700; and third air hose 800 from second air valve 700 to air powered generator 900. The preferred embodiment is shown with the following electrical connections: second electrical connection 1100 from air powered generator 900 to battery 1300; first electrical connection 1000 from air powered generator 900 to electric motor 1400; and third electrical connection 1200 from battery 1300 to electric motor 1400.

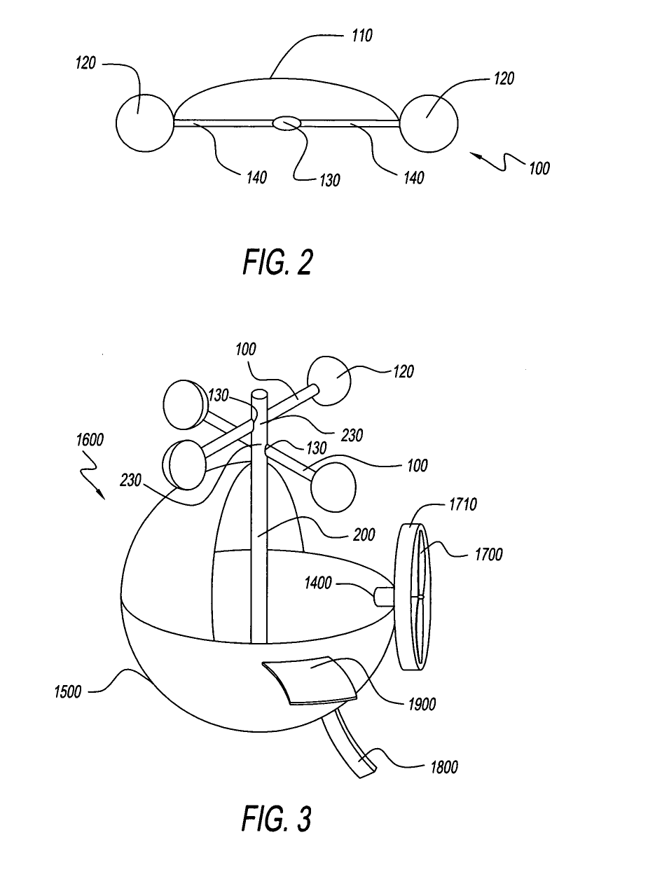

FIG. 2 shows a detailed view of a rotatable propulsion system 100. The rotatable propulsion system 100 is shown with a rotatable propulsion system boom 110 and two rotatable propulsion system wind cups 120. The rotatable propulsion system boom 110 is shown with two rotatable propulsion system rods 140 and a rotatable propulsion system connector 130.

In the preferred embodiment shown in FIG. 1 winds strike the rotatable propulsion system. Rotatable propulsion system wind cups 120 produce rotational energy that is transmitted to the air pump 300 by the mast 200; the air pump 300 produces air pressure that is transmitted to the air powered generator 900 as detailed above; the air powered generator 900 produces electricity, which is transmitted as detailed above to a battery 1300 and an electric motor 1400. The system is superior to other systems because the energy can be stored in the battery, and the battery can power a motor or other device during low wind periods.

FIG. 3 shows a preferred embodiment of the invention as a boat in a side view. The preferred embodiment is shown with two rotatable propulsion systems 100, rotatable propulsion system wind cups 120, rotatable propulsion system connector 130, mast 200, mast connector 230, electric motor 1400, hull 1500, canopy 1600, air propeller 1700 with air propeller housing 1710, rudder 1800 and wing 1900.

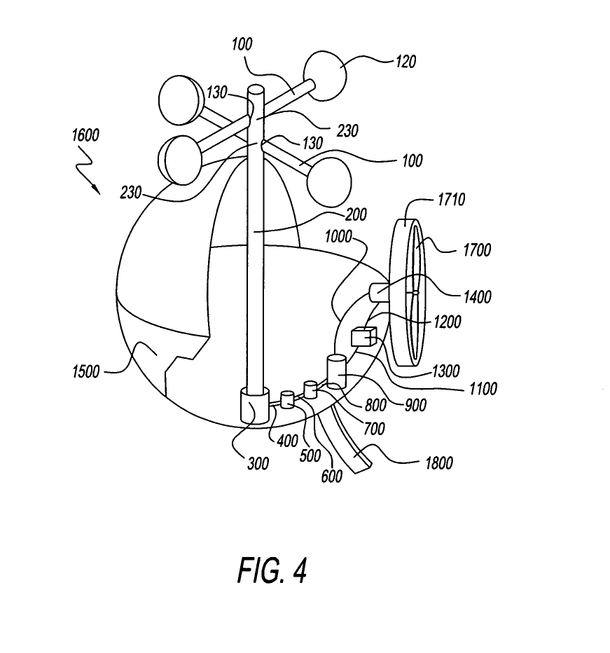

FIG. 4 shows a preferred embodiment of the invention as a boat in a cut-a-way view. The preferred embodiment is shown with two rotatable propulsion systems 100, a mast 200, air pump 300, first air valve 500, second air valve 700, air powered generator 900, battery 1300, electric motor 1400, hull 1500, canopy 1600, air propeller 1700 with air propeller housing 1710, and rudder 1800. Each rotatable propulsion system 100 is shown with a rotatable propulsion system connector 130 that is shown connecting to the mast connector 230. The mast 200 is shown connected to the air pump 300. The preferred embodiment is shown with the following air hose connections: first air hose 400 from air pump 300 to first air valve 500; second air hose 600 from first air valve 500 to second air valve 700; and third air hose 800 from second air valve 700 to air powered generator 900. The invention is shown with the following electrical connections: second electrical connection 1100 from air powered generator 900 to battery 1300; first electrical connection 1000 from air powered generator 900 to electric motor 1400; and third electrical connection 1200 from battery 1300 to electric motor 1400. The air propeller 1700 is shown attached to the electric motor 1400. Many different configurations of wind catching components, mechanical components, air pressure components and electrical components are possible. For example, the air pump 300 could be placed in the canopy 1600 with the remaining connections running along the surface of the canopy 1600 and hull 1500 making the boat more comfortable for the occupant.

In one preferred embodiment the invention may be an article of manufacture having at least two rotatable propulsion systems 100: said wind power assembly further having an air pump 300, the air pump 300 being connected to the wind power assemble and creating an air flow when rotatable propulsion systems 100 rotate in response to wind; and an air powered generator 900 connected to the wind power assembly, the air powered generator 900 capable of creating electrical current as a result of air flow from the wind power assembly. This preferred embodiment may have one or more rotatable propulsion systems and one or more wind power assemblies. As shown in the figures the rotatable propulsion systems 100 resemble conventional anemometers, with wind cups and cross pieces. However, a wide variety of shapes is possible. Possible shapes include but are not limited to: polygons, circles, and tori. Possible materials include but are not limited to: wood, metal, plastic, rubber and composites. Each rotatable propulsion system may have two or more wind cups. However, other wind catching devices other then wind cups may be used. Such devices include but are not limited to: wind socks, non-hemispherical wind cups, wind vanes, and sails. Possible materials for wind catching devices include but are not limited to: plastics, natural fabrics, artificial fabrics, metals, plastics, wood, and composites. The preferred embodiment may have a wide variety electrical loads including but not limited to: motors, batteries, lights, horns, whistles, sirens, bells, and sound systems. The preferred embodiment may have one or more electrical loads. The air connection between the air pump 300 and the air powered generator 900 may be configured in many ways. Those configurations include but are not limited to: a hose connection, a hose connection with one or more valves, a pipe connection, a pipe connection with one or more valves, a combination pipe and hose connection, a combination pipe and hose connection with one or more valves. Materials that the pipes, hoses, and valves may be formed from include but are not limited to: metal, plastic, rubber, composites, and wood. The valves may be one-way valves.

Another preferred embodiment of the invention is a boat having: a hull 1500, and a power system having a wind power assembly having at least one rotatable propulsion system 100: said wind power assembly further having an air pump 300, the air pump 300 being connected to the wind power assembly and creating an air flow when rotatable propulsion systems 100 rotate in response to wind; an air powered generator 900 connected to the wind power assembly, the air powered generator 900 capable of creating electrical current as a result of the air flow from the wind power assembly wherein the electrical current powers a motor that rotates an air propeller 1700 external to the hull 1500. The preferred embodiment may have one or more rotatable propulsion systems. The hull 1500 may be semi-circular in shape and may be inflatable. In one preferred embodiment, the boat can be used as a life preserving raft, that can be packed for storage, then inflated during an emergency. The hull 1500 may have a canopy 1600, wings 1900, and one or more rudders 1800. The materials used for hull and its various parts include but are not limited to: wood, rubber, metal, plastic, and composites. As shown in the figures the rotatable propulsion system 100 resembles conventional anemometers, with wind cups and cross pieces. However, a wide variety of shapes is possible. Possible shapes include but are not limited to: polygons, circles, and tori. Possible materials include but are limited to: wood, metal, plastic, rubber and composites. Each rotatable propulsion system may have more then two or more wind cups. However, other wind catching devices other than wind cups may be used. Such devices include but are not limited to: wind socks, non-hemispherical wind cups, wind vanes and sails. Possible materials for wind catching devices include but are not limited to: plastics, natural fabrics, artificial fabrics, metals, plastics, wood, and composites. The preferred embodiment may have two or more rotatable propulsion systems. Possible configurations of electrical power usage include but are not limited to: motor directly powered by the generator; motor powered by one or more batteries charged by the generator; motor powered by the generator and one or more batteries, batteries charged by generator. The air connection between the air pump 300 and the air powered generator 900 may be configured in many ways. Those configurations include but are not limited to: a hose connection, a hose connection with one or more valves, a pipe connection, a pipe connection with one or more valves, a combination pipe and hose connection, a combination pipe and hose connection with one or more valves. Materials that the pipes, hoses, or valves may be formed from include but are not limited to: metal, plastic, rubber, composites, and wood. The valves may be one-way valves.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. An article of manufacture, comprising:
a wind power assembly having at least two rotatable propulsion systems:
said wind power assembly further having an air pump, the air pump being connected to the wind power assembly and creating an air flow when rotatable propulsion systems rotate in response to wind; and
an air powered generator connected to the wind power assembly, the air powered generator capable of creating electrical current as a result of the air flow from the wind power assembly.

2. The article of claim 1, wherein the electric current is stored in at least one battery.

3. The article of claim 1, wherein the electric current powers at least one motor.

4. The article of claim 1, wherein the electric current powers at lease one light.

5. The article of claim 1, wherein the wind power assembly and the air powered generator are connected with a hose.

6. The article of claim 1, wherein the wind power assembly and the air powered generator are connected with a hose, and there is a one way valve on the hose.

7. The article of claim 6, wherein there is an air flow control valve on the hose.

8. The article of claim 2, wherein the battery powers at least one motor.

9. The article of claim 1, wherein the battery powers at least one light.

10. The article of claim 1, wherein the article comprises a plurality of wind power assemblies.

11. The article of claim 1, wherein the wind power assembly have a plurality of rotatable propulsion systems.

12. The article of claim 1, wherein the wind power assembly has at least two wind cups.

13. A boat, comprising:
a hull, and
a power system having a wind power assembly having at least one rotatable propulsion system:
said wind power assembly further having an air pump, the air pump being connected to the wind power assembly and creating an air flow when rotatable propulsion systems rotate in response to wind;
an air powered generator connected to the wind power assembly, the air powered generator capable of creating electrical current as a result of the air flow from the wind power assembly
wherein the electrical current powers a motor that rotates a propeller external to the hull.

14. The boat of claim 13, wherein the hull is a semi-circular in shape and inflatable.

15. The boat of claim 13, wherein the electrical current is stored in a battery and the battery powers a motor.

16. The boat of claim 13, wherein the hull has a canopy.

17. The boat of claim 13, wherein the hull has wings attached thereto

18. The boat of claim 13, wherein the hull has rudder wings.

19. The boat of claim 13, wherein the wind power assembly and the air powered generator are connected with a hose, and there is a one way valve on the hose.

20. The boat of claim 19, wherein there is an air flow control valve on the hose.
